(19) United States
(12) Patent Application Publication
(10) Pub. No.: US 2006/0133098 A1
(43) Pub. Date: Jun. 22, 2006

(54) Party lamp

(76) Inventor: Ming-Kuei Lin, Taipei Hsien (TW)

Correspondence Address: DAVID E. DOUGHERTY;Dennison, Schultz, Dougherty & Macdonald, Suite 105, 1727 King Street, Alexandria, VA, 22314-2700, US

(21) Appl. No.: 11/014,877

(22) Filed: Dec. 20, 2004

(51) Int. Cl. F21S 8/08

(52) U.S. Cl. 362/414

(57) ABSTRACT

A party lamp includes a base, a connecting rod and a light head. The connecting rod is arched and is arranged between the base and the light head. The light head has a spotlight and an a converging lens while the base consists of a revolving base with adjustable tilt angle, a discoid base disposed on two corresponding pivots of the revolving base, and a rotary plate with a spherical concave surface with flaky mirrors driven by a motor inside the discoid base. In usage, light from the spotlight passes through a converging lens and projects on the rotary spherical concave surface with flaky mirrors, then is reflected on the wall and is showing a dynamic lighting. The reflection direction or tilt angle of the spherical concave surface with flaky mirrors is adjusted by the revolving base and the discoid base so as to change the area of dynamic lighting.

### BACKGROUND OF THE INVENTION

The present invention relates to a party lamp, especially to a kind of light that emits light beam through a converging lens and then being projected on a revolving spherical concave surface with flaky mirrors. The light is reflected on the wall and is showing a dynamic lighting consisting of a plurality of revolving shadows.

Party lamps are used to produce various shapes of revolving images on the walls surrounding a dance floor or party so that a better visual effect is achieved. A party lamp design by the applicant of the present invention has been registered in Chinese utility model patent No. 99254242.1 and the U.S. design Pat. No. 431,091. This prior art project light beams on a hemisphere ball with flaky mirrors. However, although such kind of light produces a larger dynamic lighting, the shape of the shadow and the rotary pattern is rough and blurred. The lighting effect is not delicate. Therefore, there is a need for improving conventional party lamps.

### SUMMARY OF THE INVENTION

It is a primary object of the present invention to provide a party lamp including a base, a connecting rod and a light head. The light head with a spotlight is arranged on top of the connecting rod while the base is on lower part of the connecting. Light from the spotlight passes through a converging lens and projects on the base that consists of a revolving base, a discoid base disposed on two corresponding pivots of the revolving base, and a rotary plate driven by a motor inside the discoid base. A spherical concave surface with flaky mirrors is arranged on the rotary plate. The light from the light head projects on the spherical concave surface with flaky mirrors and then is reflected on the wall and is showing a dynamic lighting consisting of a plurality of revolving shadows.

It is another object of the present invention to provide a party lamp that adjusts the reflection direction or tilt angle of the spherical concave surface with flaky mirrors by the revolving base and the discoid base so as to change the area of dynamic lighting.

### BRIEF DESCRIPTION OF THE DRAWINGS

FIG. 1 is a perspective view of an embodiment in accordance with the present invention;

FIG. 2 is an explosive view of the embodiment in FIG. 1;

FIG. 3 is a cross-sectional view of the embodiment in FIG. 1;

FIG. 4 & FIG. 5 are a schematic drawing showing the adjustment of tilt angle of a discoid base in accordance with the present invention;

FIG. 6 is a schematic drawing showing the adjustment of the direction of the discoid base in FIG. 1.

### DETAILED DESCRIPTION OF THE PREFFERED EMBODIMENT

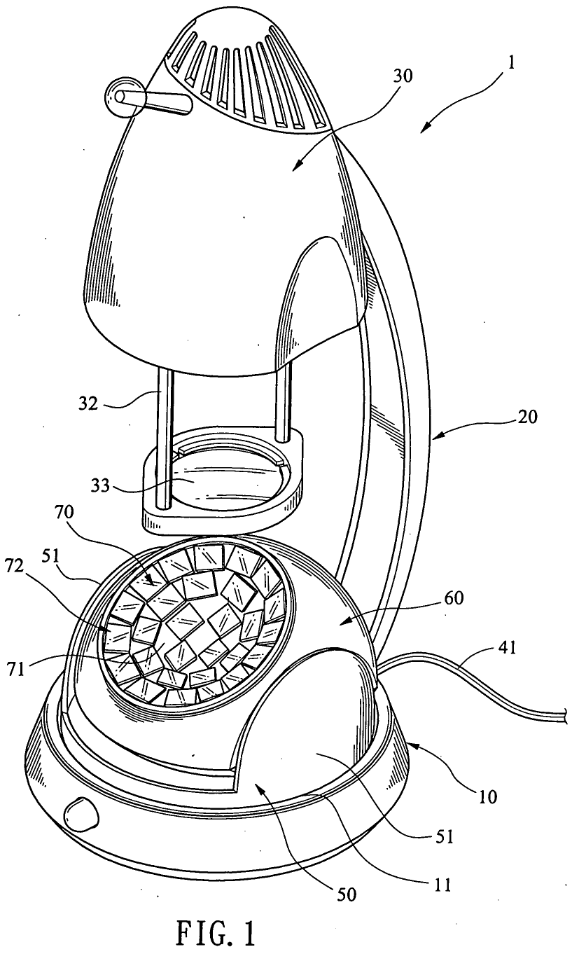

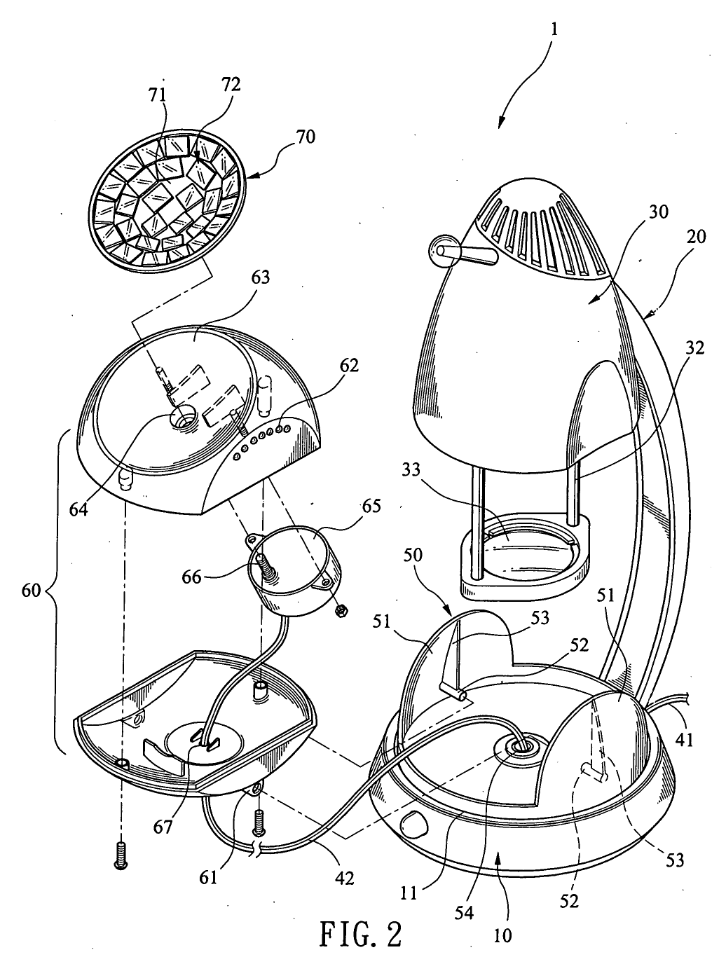

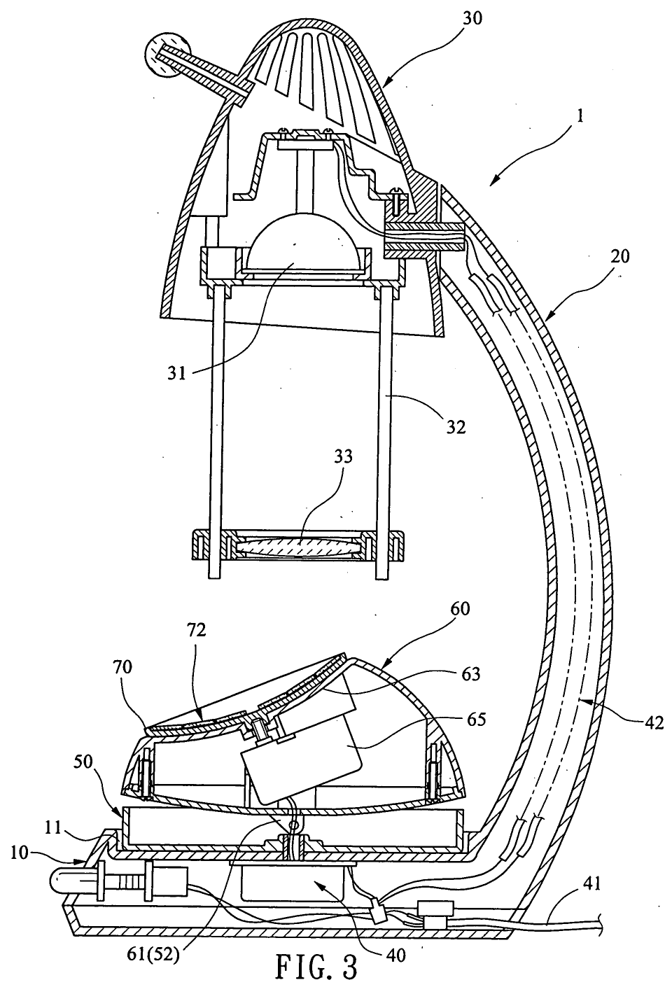

Refer to FIG. 1, FIG. 2 & FIG. 3, a party lamp 1 in accordance with the present invention is composed by a base 10, a connecting rod 20 and a light head 30. An electric fixture 40 is disposed inside the base 10 and is connected with an external power source by a wire 41. The connecting rod 20 is arched and is arranged between the base 10 and the light head 30. A wire 42 is arranged inside the connecting rod 20 and is connected to a spotlight 31 on the light head 30. The light head 30 consists of a spotlight 31, two parallel suspended rods 32 extending downwards, and an adjustable converging lens 33 that moves upwards or downwards arranged between the two suspended rods 32. Thus the light from the spotlight 31 passes through the converging lens 33 and projects downwards to the base 10.

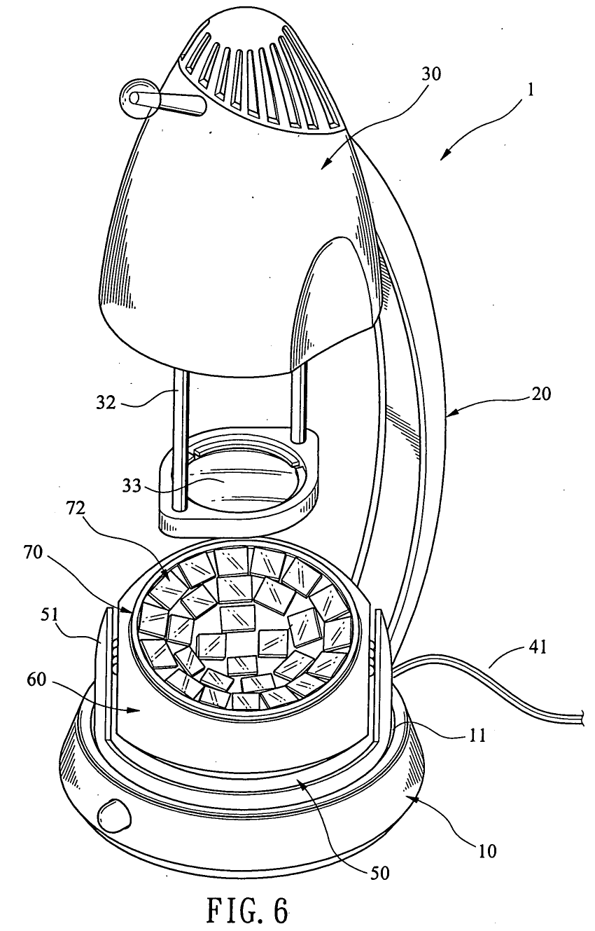

A revolving base 50, a discoid base 60, and a rotary plate 70 are arranged on the base 10. The revolving base 50 is arranged on a round slot 11 of the base 10 for adjusting the direction of the party lamp, as shown in FIG. 1 & FIG. 6. Two vertical corresponding frames 51 are disposed on outer flange of the revolving base 50 while a pivot 52 and a stopper 53 are installed on inner side of the frame 51. An insertion hole 54 is on the center of the base 10 for inserting the wire 42 of the electric fixture 40.

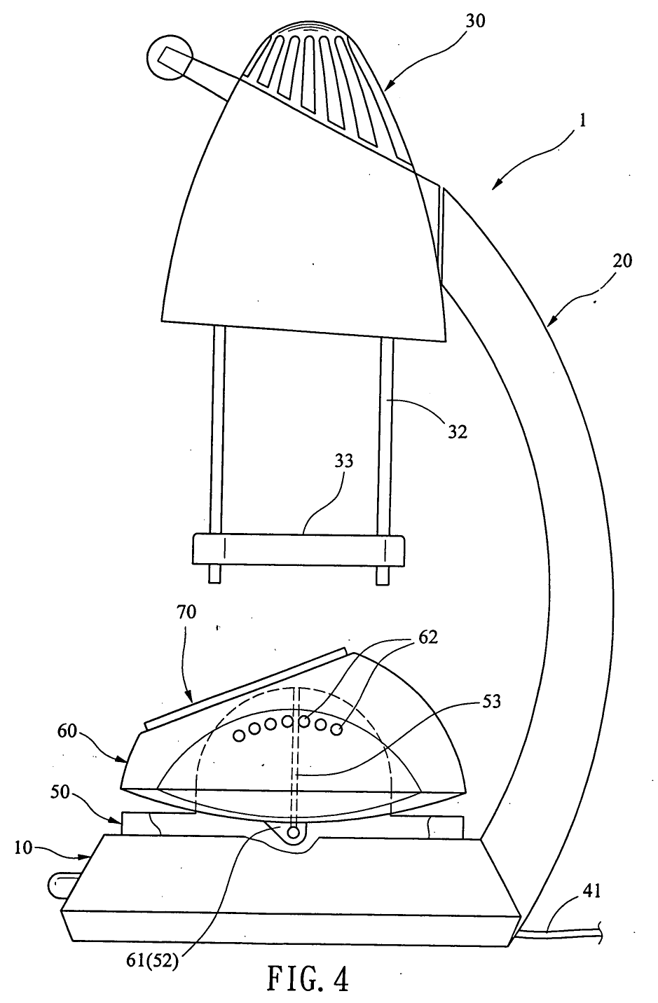

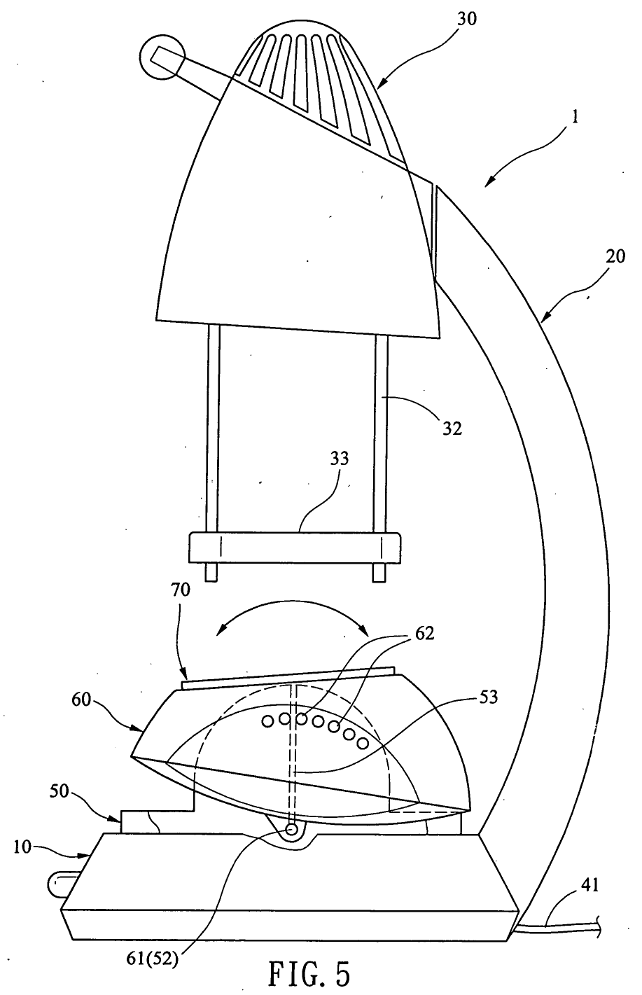

The discoid base 60 is a hollow shell with two corresponding bearings 61 on the two sides of the bottom side thereof. The bearings 61 correspond to and assemble with the pivots 52 of the revolving base 50. A plurality of projecting points 62 is arranged in a fan shape on the upper surface of the discoid base 60. When discoid base 60 is adjusted for tilt angle on the revolving base 50, the stopper 53 of the revolving base 50 is locked between two projecting points 62 so as to make the discoid base 60 be localized in that angle (position), as shown in FIG. 4, FIG. 5. A shallow spherical slot 63 is arranged on top surface of the discoid base 60 with an insertion hole 64 in the center thereof. A motor 65 is arranged inside the discoid base 60 and a drive axle 66 corresponding to the position of the insertion hole 64. And an insertion hole 67 is arranged on the bottom of the discoid base 60 for inserting the wire 42 of the electric fixture 40 through the insertion hole 54 and the insertion hole 67 to connect with the motor 65.

The rotary plate 70 is a spherical concave plate with similar shape of the spherical slot 63 and is connected to the motor 65 by a drive axle 66 inserting through the insertion hole 64 for being driven to rotate. A spherical concave surface with flaky mirrors 72 having a spherical concave surface 71 with a plurality of small pieces of mirrors is arranged on the rotary plate 70.

In usage, light from the spotlight 31 passes through the converging lens 33, projects on the spherical concave surface with flaky mirrors 72 and then being reflected on the wall. Thus dynamic lighting composed by a plurality of rotary light shadow is showing on the wall. Because the spherical concave surface with flaky mirrors 72 in accordance with the present invention is different from conventional party lamps made of a semiglobe with flaky mirrors (spherical convex surface). Therefore, the present invention produces dynamic lighting with shapes and rotary pattern different from conventional party lamps, having better dynamic effect.

In addition, by the revolving base and the discoid base, the reflection direction of the spherical concave surface with flaky mirrors 72 is adjustable, as shown in FIG. 1 & FIG. 6, or the tilt angle of the spherical concave surface with flaky mirrors 72 is adjustable, as shown in FIG. 4 & FIG. 5. And at the same time the area of the dynamic lighting is also changed.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A party lamp comprising a light head, a connecting rod and a base having a revolving base, a discoid base, and a rotary plate, wherein:
the light head is arranged on top of the connecting rod and having a spotlight, two parallel suspended rods extending downwards, and an adjustable converging lens that moves upwards or downwards arranged between the two suspended rods; light from the spotlight passes the converging lens and projects on the base;
the connecting rod is arched and is arranged between the base and the light head with a wire arranged therein that connects to the spotlight of the light head;
the base having an electric fixture connected with an external power source by a wire;
the revolving base is rotatable and is arranged on a round slot of the base with two vertical corresponding frames are disposed on outer flange thereof while a pivot and a stopper are installed on inner side of the frame; an insertion hole is on the center thereof for inserting the wire of the electric fixture;
the discoid base is a hollow shell with two corresponding bearings on the two sides of the bottom side thereof that assemble with the pivots of the revolving base so as to adjust the tilt angle of the discoid base arranged between the frames of the revolving base; a shallow spherical slot is arranged on top surface with an insertion hole in the center thereof; a motor is arranged therein with a drive axle corresponding to the position of the insertion hole of the spherical slot; and an insertion hole is arranged on the bottom of the discoid base for inserting of the wire of the electric fixture to connect with the motor;
the rotary plate is a spherical concave plate with similar shape of the spherical slot for being assembled with the spherical slot, and is connected to the motor by a drive axle inserting through the insertion hole being driven to rotate; the a spherical concave surface with flaky mirrors over the rotary plate is formed by a spherical concave surface with a plurality of small pieces of mirrors;
light from the spotlight passes through a converging lens and projects on the rotary spherical concave surface with flaky mirrors, then is reflected on the wall and is showing a dynamic lighting formed by a plurality of rotary shadows.

2. The party lamp as claimed in claim 1, wherein a plurality of projecting points is arranged in a fan shape above the bearing of the discoid base; when discoid base is adjusted for tilt angle on 5 the revolving base, the stopper of the revolving base is locked between two projecting points so as to make the discoid base 60 be localized.
